(19) United States
(12) Patent Application Publication
(10) Pub. No.: US 2024/0209549 A1
(43) Pub. Date: Jun. 27, 2024

(54) PROCESS OF MAKING A SIZED AND RESIN-COATED FIBER

(71) Applicant: Zoltek Companies, Inc., Bridgeton, MO (US)

(72) Inventors: Maurice Geli, Chesterfield, MO (US); David Michael Corbin, Saint Peters, MO (US)

(73) Assignee: Zoltek Companies, Inc., Bridgeton, MO (US)

(21) Appl. No.: 18/285,781

(22) PCT Filed: Apr. 8, 2022
(86) PCT No.: PCT/US2022/023982

§ 371 Date: Oct. 5, 2023

Related U.S. Application Data
(60) Provisional application No. 63/172,970, filed on Apr. 9, 2021.

(51) Int. Cl. D01F 11/14; D01F 8/04; D01F 8/18; D01F 9/22

(52) U.S. Cl. CPC D01F 11/14; D01F 8/04; D01F 8/18; D01F 9/22; D10B 2101/12

(57) ABSTRACT

A method of making a sized and resin-coated fiber tow for use in a fiber reinforced composite. the method comprising the steps of providing a fiber, contacting at least a portion of the fiber with a sizing slurry to form a sized and resin-coated fiber, the sizing slurry comprising 0.1-25% by weight of a sizing agent and 20-80% by weight of a matrix-resin powder in a solvent, based on the total weight of the sizing slurry. wherein the total solid content, including the sizing agent and the matrix-resin powder, of the sizing slurry is greater than 30 wt. %. The method further comprising drying the sized and resin-coated fiber at a temperature below the melting point of the matrix-resin powder, thereby forming a dried sized and resin-coated fiber and winding the dried sized and resin-coated fiber onto a spool.

### CROSS-REFERENCE TO RELATED APPLICATIONS

This application claims priority to U.S. Provisional Application No. 63/172,970, filed on Apr. 9, 2021, the disclosure of which is incorporated herein by reference in its entirety, for all purposes.

### FIELD OF THE INVENTION

The present disclosure relates generally to sized and resin-coated fibers and a method of making such fiber tows for use in a fiber reinforced composite. The present disclosure also relates generally to sizing composition for use in the production of sized and resin-coated fibers.

### BACKGROUND OF THE INVENTION

The fiber reinforced composite material has been developed over the last few decades and are being used in many industries to maximize mechanical properties while retaining or reducing the weight by combining reinforcing fibers and thermoplastic or thermosetting polymers.

However, there is a need for processes with fewer steps to decrease overall cost of manufacturing.

### SUMMARY OF THE INVENTION

In an aspect of the invention, there is a method of making a sized and resin-coated fiber tow for use in a fiber reinforced composite. The method comprises the steps of providing a carbon fiber and contacting at least a portion of the fiber with a sizing slurry to form a sized and resin-coated fiber, the sizing slurry comprising 0.1-25 wt. % of a sizing agent and 20-80 wt. % of a matrix-resin powder in a solvent, wherein the amounts in wt. % are based on the total amount of the sizing slurry, such that the total solid content, including the sizing agent and the matrix-resin powder, of the sizing slurry is greater than 30 wt. %. The method also comprises drying the sized and resin-coated fiber at a temperature below the melting point of the matrix-resin powder, thereby forming a dried sized and resin-coated fiber and winding the dried sized and resin-coated fiber onto a spool.

In an aspect, the method is a continuous process further comprising steps (i)-(iv) before the step of contacting at least a portion of the fiber with a sizing slurry:
(i) stabilizing a precursor fiber at a temperature in the range of 200-300° C. to form a stabilized precursor fiber;
(ii) carbonizing the stabilized precursor fiber at a temperature in the range of 1000-1500° C. to form a carbonized fiber;
(iii) graphitizing the carbonized fiber at a temperature in the range of 2000-3000° C. to form a carbon fiber; and
(iv) optionally treating at least a portion of a surface of the carbon fiber.

In an embodiment, the drying step provides the dried sized and resin-coated fiber having greater than 21 wt. % and less than 80 wt. % of the sizing agent and the matrix-resin based on the total amount of the dried sized and resin-coated fiber.

In another embodiment, the contacting step includes providing the sizing slurry comprising the matrix-resin powder having an average particle size in the range of 1-500 μm. In another embodiment, the contacting step includes providing the sizing slurry comprising the sizing agent comprising at least one of an epoxy, a phenoxy, a polyester, a polyamide, a polyimide, a polypropylene, a polyurethane, a polyvinyl acetate, a vinyl-ester, a polyvinyl alcohol, an ethylene/vinyl alcohol copolymer, a silane-grafted polyvinyl alcohol and a silane-grafted ethylene/vinyl alcohol copolymer, a silane-grafted polyvinyl alcohol, a silane-grafted ethylene/vinyl alcohol copolymer, and the like.

In an aspect, the contacting step includes providing the sizing slurry comprising the matrix-resin powder which is a thermoset (co)polymer, a thermoplastic (co)polymer, or alloys and blends thereof. In an embodiment, the contacting step includes providing the sizing slurry comprising the thermoset (co)polymer comprising epoxy, vinyl ester polyester, bismaleimide, cyanate ester, polyurethane, or mixtures thereof. In another embodiment, the contacting step includes providing the sizing slurry comprising the thermoplastic (co)polymer comprising polyethylene, polypropylene, polycarbonate, polyethylene terephthalate, polybutylene terephthalate, polyamide-6, polyamide-66, polyamide-11, polyamide-12, polyamide-46, polyetherimide, polyphenylene sulfide, polysulfone, polyimide, polyethersulfone, polyether-ketone-ketone, polyether-ether-ketone, or mixtures thereof.

In an aspect of the invention, the method further comprises molding the dried sized and resin-coated fiber without impregnating the dried sized and resin-coated fiber with additional matrix-resin.

In yet another aspect, there is a fiber reinforced composite prepared by the method as disclosed hereinabove.

In an aspect, there is a sizing slurry comprising 0.1-25 wt. % of a sizing agent and 20-80 wt. % of a matrix-resin powder in a solvent, wherein the amounts in wt. % are based on the total amount of the sizing slurry, such that the total solid content, including the sizing agent and the matrix-resin powder, of the sizing slurry is greater than 30 wt. %.

In another aspect, there is a sized and resin-coated fiber comprising:
(i) a carbon fiber,
(ii) a sizing agent disposed on at least a portion of the fiber, and
(iii) a matrix-resin disposed on at least a portion of the fiber and adhered to the sizing agent,
wherein the sized and resin-coated fiber has greater than 21 wt. % and less than 80 wt. % of the sizing agent and matrix-resin, based on the total weight of the sized and resin-coated fiber.

In an aspect, there is a continuous method of making a sized and resin-coated carbon fiber tow for use in a carbon fiber reinforced composite, the method comprising the steps of:
a) unwinding a spool of polyacrylonitrile (PAN) fiber;
b) stabilizing the PAN fiber at a temperature in the range of 200-300° C. to form a stabilized PAN fiber;
c) carbonizing the stabilized PAN fiber at a temperature in the range of 1000-1500° C. to form a carbonized fiber;
d) graphitizing the carbonized fiber at a temperature in the range of 2000-3000° C. to form a carbon fiber;
e) treating at least a portion of a surface of the carbon fiber;
f) contacting at least a portion of the fiber with a sizing slurry to form a sized and resin-coated fiber, the sizing slurry comprising 0.1-25 wt. % of a sizing agent and 20-80 wt. % of a matrix-resin powder in a solvent, wherein the amounts in wt. % are based on the total amount of the sizing slurry, such that the total solid content, including the sizing agent and the matrix-resin powder, of the sizing slurry is greater than 30 wt. %;
g) drying the sized and resin coated carbon fiber at a temperature below the melting point of resin, thereby forming a dried sized and resin-coated carbon fiber; and
h) winding the dried sized and resin-coated carbon fiber onto a spool.

In an aspect of the continuous method, the drying step provides the dried sized and resin-coated carbon fiber having greater than 21 wt. % and less than 80 wt. % of the sizing agent and the matrix-resin based on the total amount of the dried sized and resin-coated carbon fiber.

In another aspect, the continuous method further comprises molding the dried sized and resin-coated fiber without impregnating the dried sized and resin-coated carbon fiber with additional matrix-resin.

### BRIEF DESCRIPTION OF THE DRAWINGS

FIG. 1 schematically depicts a process of making a sized and resin-coated fiber for use in fiber reinforced composite, in accordance with embodiments of the present invention.

FIG. 2 schematically depicts a continuous process of making a sized and resin-coated carbon fiber for use in making a molded fiber reinforced composite, in accordance with embodiments of the present invention.

FIG. 3 schematically depicts another continuous process of making a sized and resin-coated carbon fiber for use in fiber reinforced composite, in accordance with embodiments of the present invention.

FIG. 4 schematically depicts a process of making a molded carbon fiber-reinforced composite directly from the sized and resin-coated carbon fiber without impregnating the sized and resin-coated carbon fiber with additional matrix-resin, in accordance with embodiments of the present invention.

FIG. 5 shows a photograph of spools of sized and resin-coated carbon fiber, in accordance with embodiments of the present invention.

FIG. 6 shows a photomicrograph of sized and resin-coated carbon fibers, in accordance with embodiments of the present invention.

### DETAILED DESCRIPTION OF THE INVENTION

Carbon fibers are one of the best ways to maximize mechanical properties and light weighting. Carbon fibers are typically classified according to tensile moduli, such as, for example:
low modulus (<200 GPa)
standard modulus (˜230 GPa)
intermediate modulus (˜300 GPa)
high modulus (>350 GPa)
ultra-high modulus (>600 GPa)

Other fibers, such as, e.g., basalt, quartz, alumina, silicon carbide, nylon, polyester, polypropylene, aramid, acrylic, etc., can also be used in such capacities. Many natural fibers, such as, e.g., hemp, jute, etc., can be used for the manufacture of “green” reinforced plastic composites. However, regardless of the type of fiber used as reinforcement, sizing or binder on the fiber is generally required to protect it during the manufacturing process and to enhance bonding between the fiber and the plastic matrix-resin.

Generally, the process of making fiber reinforced composite comprises fiber production including sizing step to produce sized fibers, polymer production, impregnation of resin into sized fiber sheets or fabrics to form an intermediate product, called prepregs. These prepregs are then molded to a desired shape without the addition of any more resin. The process may comprise post molding steps, including, but not limited to, painting, trimming, machining, and bonding. Some processes such as infusion can combine the steps of impregnation and molding into one step.

Fibers often require treatment, commonly referred to as spin finish, binder, or size, before use in making fiber reinforced composite. For textile fibers, the purpose of spin finish is to provide surface lubricity, anti-static, dye affinity, wetting or anti-wetting, and abrasion resistance. If the textile fibers are used for plastic reinforcement, the spin finish or binder may contain a resin dispersion to enhance its compatibility to the plastic to be reinforced. For inorganic fibers used for plastic reinforcement, binder or size provides surface lubricity, anti-static, wetting, anti-oxidation, abrasion resistance, resin bonding, and compatibility. This principle also applies to plant-based natural fibers.

As used herein, the terms “fiber” and “fibers” includes, continuous fibers, nanotube(s), microfiber(s), and nanofiber(s).

Suitable fibers that may be used to form the sized and resin-coated fibers according to the present invention include, but are not limited to, carbon fibers. The carbon fibers can be of any class, type, or grade known in the art. Examples of grades of carbon fiber that may be used to form the sized reinforcing filler according to the present invention include, but are not limited to, low modulus carbon fibers, standard modulus carbon fibers, intermediate modulus carbon fibers, high modulus carbon fibers, and ultra-high modulus carbon fibers. The carbon fiber that may be used to form the sized reinforcing filler according to the present invention may be derived from either polyacrylonitrile (PAN) or pitch.

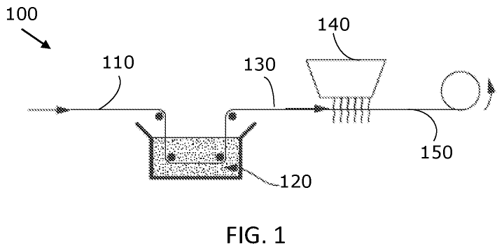

In an aspect of the present invention, the present disclosure provides a method of making a sized and resin-coated fiber tow for use in a fiber reinforced composite, as shown in FIG. 1. The method 100 comprises the steps of providing a fiber 110 and contacting at least a portion of the fiber 110 with a sizing slurry 120 to form a sized and resin-coated fiber 130, drying 140 the sized and resin-coated fiber 130 at a temperature below the melting point of the matrix-resin powder, thereby forming a dried sized and resin-coated fiber 150 and winding the dried sized and resin-coated fiber 150 onto a spool, bobbin, tow, or roving.

The step of contacting at least a portion of the fiber 110 with a sizing slurry 120 comprises forming a sizing slurry 120 in-situ by adding a matrix-resin powder to a sizing composition comprising a sizing agent and a solvent, and mixing with a slurry agitator to keep the matrix-resin powder in suspension and to prevent the matrix-resin powder from settling out. The sizing slurry 120 may comprise 0.1-25 wt. %, or 0.5-20 wt. %, or 1-15 wt. % of a sizing agent and 20-80%, or 25-75%, or 30-70% of a matrix-resin powder in a solvent, based on the total weight of the sizing slurry. The total solid content, including the sizing agent and the matrix-resin powder, of the sizing slurry 120 is greater than 30%, or 35%, or 40%, or 45%, or 50%, or 55%, by weight, based on the total weight of the sizing slurry. In an embodiment, the matrix-resin powder is present in an amount in the range of 30-80%, or 35-70%, or 40-60% by weight, based on the total weight of the sizing slurry. Conventionally, the amount of the sizing agent is smaller than the matrix-resin powder in the sizing slurry, as minimum amount of 30% by weight of the matrix-resin is needed to fill the voids between the round carbon fiber filament in a fiber reinforced composite. Any suitable solvent may be used. In an embodiment, the solvent comprises water. In another embodiment, the solvent comprises water and at least one water miscible solvent, such as ethanol. In one embodiment, the solvents consists of 10% by volume of ethanol in water. In yet another embodiment, the solvent consists of water. The solvent may be present in any suitable amount, such as in the range of 15-70 wt. %, or 19-60 wt. %, 20-55 wt. % based on the total weight of the sizing slurry.

Typically, sizing agent can be one or more of a compound, an oligomer and/or a polymer. In general, the sizing agent, by forming a film on the carbon fiber, provides optimal processing/handling of the carbon fibers and increase compatibility with the matrix-resin when forming a carbon fiber-reinforced composite. On the other hand, the polymer used as the matrix-resin powder in the sizing slurry of the present invention is intended to serve as the matrix-resin of the carbon fiber-reinforced composite.

In an aspect of the present invention, the sizing agent comprises at least one of an epoxy, a phenoxy, a polyester, a polyamide, a polyimide, a polypropylene, a polyurethane, a polyvinyl acetate, a vinyl-ester, a polyvinyl alcohol, an ethylene/vinyl alcohol copolymer, a silane-grafted polyvinyl alcohol and a silane-grafted ethylene/vinyl alcohol copolymer, a silane-grafted polyvinyl alcohol, a silane-grafted ethylene/vinyl alcohol copolymer, and the like.

The matrix-resin powder according to the present invention may be any suitable thermoset (co)polymer and/or thermoplastic (co)polymer known in the art. In an embodiment, the matrix-resin powder has an average particle size in the range of 1-500 μm, or 10-300 μm, or 20-250 μm.

Examples of such thermoset (co)polymers include, but are not limited to, epoxy, vinyl ester polyester, bismaleimide, cyanate ester, polyurethane, or mixtures thereof. Examples of most commonly used thermoset matrix-resin powders, include, but are not limited to unsaturated polyester, epoxy, vinyl ester, phenolic, and thermoset polyurethane. Other exotic resins, such as polyimide, bismaleimide (BMI), benzoxazine, and silicone, are also used, but have very small market shares due to their high cost. Sizing agents commonly used to size the fibers for such matrix-resin include polyvinyl acetate, vinyl acetate-ethylene, vinyl ester, epoxy, phenoxy, unsaturated polyester, saturated polyester, and polyurethane.

Examples of thermoplastic (co)polymers include, but are not limited to, polyethylene, polypropylene, polycarbonate, polyethylene terephthalate, polybutylene terephthalate, polyamide-6, polyamide-66, polyamide-11, polyamide-12, polyamide-46, polyetherimide, polyphenylene sulfide, polysulfone, polyimide, polyethersulfone, polyether-ketone-ketone, polyether-ether-ketone, or mixtures thereof. In certain embodiments, the matrix-resin powder according to the present invention may be a mixture of two or more thermoplastic (co)polymers. For thermoplastic fiber-reinforced composites, polyolefins (e.g., polyethylene (PE) and polypropylene (PP)), acrylonitrile butadiene styrene (ABS), polyvinyl chloride (PVC), and polystyrene (PS) dominate the volume of matrix-resin consumption. Among the fiber-reinforced composites, nylon has the largest percentage of volume, followed by thermoplastic polyester. Conventional sizing agents used to reinforce nylon matrix-resins, include, but are not limited to polyurethane dispersions (PUD), polyamide dispersions, epoxy dispersions, acrylics, and maleic anhydride-grafted ethylene. Conventional sizing agents used to reinforce thermoplastic polyester matrix-resins, include, but are not limited to epoxy dispersions, polyurethane dispersions, and polyester dispersions.

The sizing slurry may also include a coupling agent and/or a processing aid (i.e., lubricant, wetting agent, neutralizing agent, antistatic agent, antioxidant, nucleating agent, crosslinker, and any combination thereof) in addition to the sizing agent (film formers) and the matric-resin powder. Examples of such coupling agents include, but are not limited to, chromium (III) methacrylate (available as Volan® from Zaclon LLC), silane, and titanate. Examples of such processing aids include, but are not limited to, lubricants, wetting agents, neutralizing agents, antistatic agents, antioxidants, nucleating agents, crosslinkers, and any combination thereof. In certain embodiments, the sized and resin-coated fibers according to the present invention may further comprise a cationic lubricant and an anti-static agent.

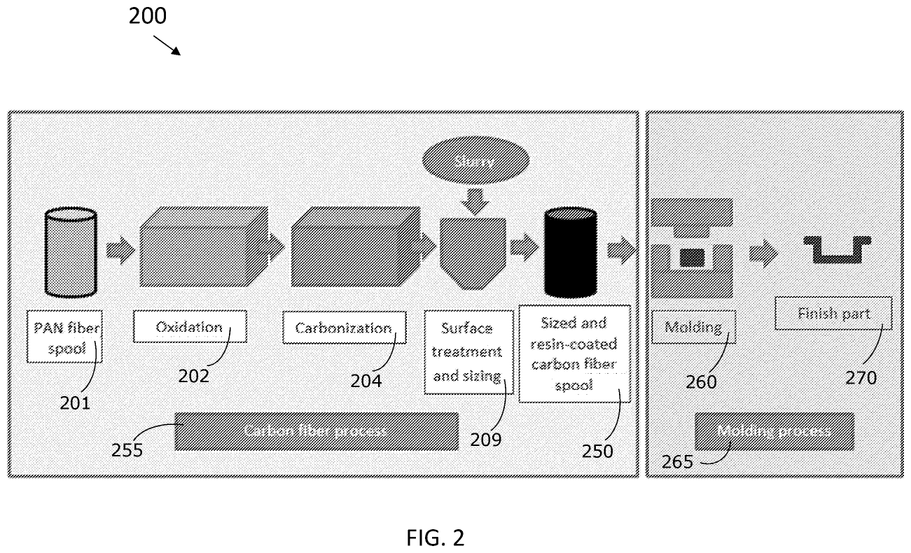

In an aspect of the invention, there is a continuous process for making a molded carbon fiber reinforced composite. FIG. 2 provides an overview of such a process combining two sub processes—a process 255 of making a carbon fiber 250 and a process 265 of molding 260 the carbon fiber 250 directly into a molded carbon fiber reinforced composite 270. In an embodiment the two processes 255 and 265 are separate and takes place at two different manufacturing locations. In another embodiment, two processes 255 and 265 are part of one process and takes place at one manufacturing location. In an aspect of the invention, the method of making a sized and resin-coated carbon fiber tow is a continuous process 200, as shown in FIG. 2. The continuous process 200 comprises the steps for making a carbon fiber before the step of contacting at least the portion of the fiber with the sizing slurry. The continuous process 200 comprises unwinding a spool of polyacrylonitrile (PAN) fiber 201, and oxidizing 202 the precursor fiber 201 to form a stabilized precursor fiber. The process 200 further comprises a carbonization step 204 to form a carbon fiber, the carbonization step may include graphitization, and a treatment/sizing step 209 to form a sized and resin-coated carbon fiber 250. As shown in FIG. 2, the process may further comprise molding 260 the sized and resin-coated fiber directly from the spool without impregnating the sized and resin-coated carbon fiber 250 with additional matrix-resin to form a molded fiber reinforced composite product 270.

In an aspect of the invention, the step of providing a fiber includes

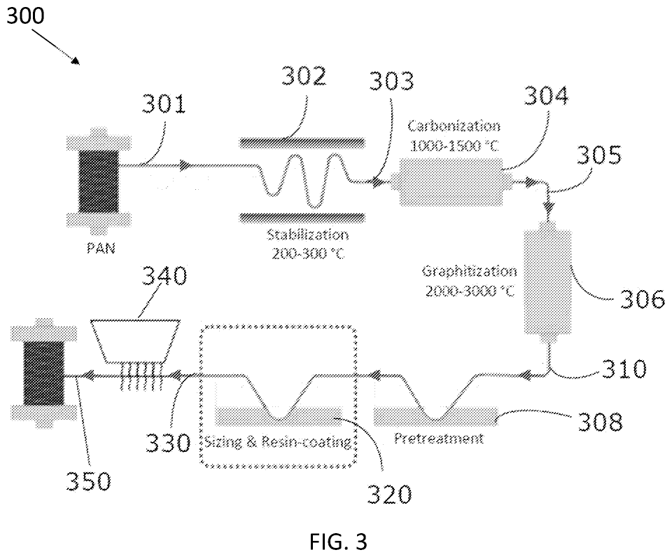

making a carbon fiber from a precursor fiber, such as PAN. FIG. 3 shows another embodiment of the present invention, a continuous process 300 of making a sized and resin-coated carbon fiber tow. The continuous process 300 comprises the steps for making a carbon fiber before the step of contacting at least the portion of the fiber with the sizing slurry. The continuous process 300 comprises unwinding a spool of precursor fiber 301, such as polyacrylonitrile (PAN) fiber, and stabilizing 302 the precursor fiber 301 at a temperature in the range of 200-300° C. to form a stabilized precursor fiber 303. The process further comprises carbonizing 304 the stabilized precursor fiber 303 at a temperature in the range of 1000-1500° C. to form a carbonized fiber 305, graphitizing 306 the carbonized fiber 305 at a temperature in the range of 2000-3000° C. to form a carbon fiber 310, and optionally pre-treating 308 at least a portion of a surface of the carbon fiber 310.

After carbonizing, the fibers have a surface that does not bond well with the epoxies and other materials used in composite materials. Hence, the at least a portion of the fibers are treated for better bonding properties, by making their surface slightly oxidized. The addition of oxygen atoms to the surface provides better chemical bonding properties and also etches and roughens the surface for better mechanical bonding properties. Oxidation can be achieved by immersing the fibers in various gases such as air, carbon dioxide, or ozone; or in various liquids such as sodium hypochlorite or nitric acid. The fibers can also be coated electrolytically by making the fibers the positive terminal in a bath filled with various electrically conductive materials. The surface treatment process must be carefully controlled to avoid forming tiny surface defects, such as pits, which could cause fiber failure.

The process 300 further comprises a treatment/sizing step comprising the step of contacting at least a portion of the fiber 310 with a sizing slurry 320 to form a sized and resin-coated fiber 350. The step of contacting further comprises forming in-situ a sizing slurry 320 by adding a matrix-resin powder to a sizing composition comprising a sizing agent and a solvent, and mixing with a slurry agitator to keep the matrix-resin powder in suspension and to prevent the matrix-resin powder from settling out. The sizing slurry 320 comprises 0.1-25 wt. %, or 0.5-20 wt. % , or 1-15 wt. % of a sizing agent and 20-80 wt. %, or 25-75 wt. %, or 30-70 wt. % of a matrix-resin powder in a solvent, wherein the amounts in wt. % are based on the total amount of the sizing slurry, such that the total solid content, including the sizing agent and the matrix-resin powder, of the sizing slurry is greater than 30 wt. % to form a sized and resin-coated carbon fiber 350.

The process 300 further comprises a drying step 340 comprising drying the sized and resin coated carbon fiber 330 at a temperature below the melting point of matrix-resin, thereby forming a dried sized and resin-coated carbon fiber 350. In an embodiment, the drying step 340 provides the dried sized and resin-coated carbon fiber 350 having greater than 21 wt. % and less than 80 wt. %, or greater than 25 wt. % and less than 75 wt. %, or greater than 30 wt. % and less than 70 wt. %, of the sizing agent and the matrix-resin, based on the total amount of the dried sized and resin-coated carbon fiber.

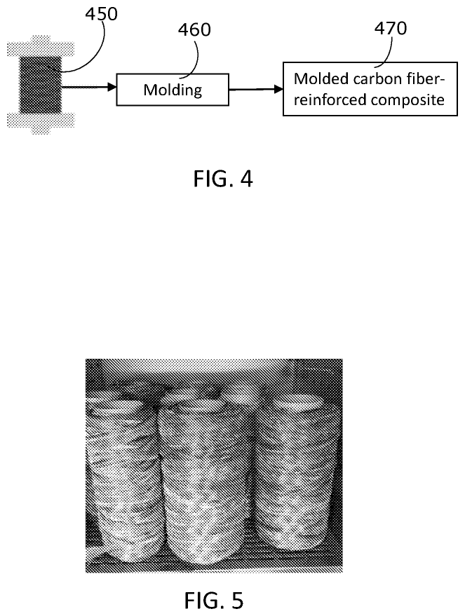

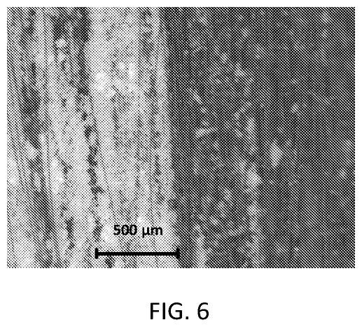

In an aspect of the invention, the method may further comprise molding the dried sized and resin-coated fiber directly from the spool without impregnating the dried sized and resin-coated carbon fiber with additional matrix-resin, as shown in FIG. 4.

In another aspect, there is a fiber reinforced composite prepared by the method as disclosed hereinabove.

In another aspect, there is a sizing slurry comprising 0.1-25 wt. %, or 0.5-20 wt. %, or 1-15 wt. % of a sizing agent and 20-80 wt. %, or 25-75 wt. %, or 30-70 wt. % of a matrix-resin powder in a solvent, wherein the amounts in wt. % are based on the total amount of the sizing slurry, such that (i) the total solid content, including the sizing agent and the matrix-resin powder, of the sizing slurry is greater than 30 wt. % and (ii) the amount of the matrix-resin powder is greater than that of the sizing agent.

In yet another aspect, there is a sized and resin-coated fiber comprising a carbon fiber, a sizing agent disposed on at least a portion of the fiber, and a matrix-resin disposed on at least a portion of the fiber and adhered to the sizing agent, wherein the sized and resin-coated fiber has greater than 21 wt. % and less than 80 wt. %, or greater than 25 wt. % and less than 75 wt. %, or greater than 30 wt. % and less than 70 wt. %, of the sizing agent and the matrix-resin, based on the total weight of the sized and resin-coated fiber.

In yet another aspect of the present invention, the present disclosure provides for articles, such as molded components, formed from the fiber-reinforced composites according to the present invention, as well as products including such articles. Such articles include unidirectional reinforced thermoplastic tapes, randomized continuous mats, long chopped mats, pelletized long compounds, and extruded long logs. In an embodiment, there is a component comprising the article, as disclosed hereinabove, wherein the component is configured for use in one or more of automotive, appliance, and electronic assembly. Examples of such articles include, but are not limited to, automotive door liners, front end modules, air intake manifolds, bumper beams, motorbike boots, car cooling fan blades, air conditioner fan blades, pump housings, automotive body panels, dashboard carriers, multi-wing impellers, lift gates, truck liners, automotive vertical panels, instrument panel carriers, door panel structures, seating structures, under hood components, gasoline doors, mirror housings, front end carriers, dash board carriers, door base plates, underbody covers, front undertrays, washing machine tubs, airbag housings, business machines, electronics packaging, and hard disk drive. Of course, many other types of products can be formed.

The following examples are included to demonstrate preferred embodiments. It should be appreciated by those of skill in the art that the techniques disclosed in the examples which follow represent techniques discovered by the inventor to function well in the practice of the products, compositions, and methods described herein, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the disclosure.

### EXAMPLES

Materials Used

Polyamide 6 (PA6) spheroidal resin powder (ORGASOL® 2001) was obtained from Arkema, King of Prussia, PA. Carbon fiber tow ZOLTEK PX35 was obtained from Zoltek Corporation, Bridgeton, MO. Hydrosize U6-01 was obtained from Michelman, Inc., Cincinnati, OH.

### Example 1: Method of Making a Sizing Slurry

A sizing slurry was made by adding 35 wt. % PA6 Orgasol® 2001 in a solution comprising 5% Hydrosize U6-01 as a sizing agent and 60% distilled water. The mixture was stirred for about 15 min to form a sizing slurry.

### Example 2: Method of Making Sized and PA6 Resin-Coated Carbon Fibers

A carbon fiber tow PX35 was sized with the sizing slurry of Example 1 and dried at 150 ° C. for about 5-7 minutes to form a sized and PA6 resin-coated carbon fiber. After drying the sized and PA6 resin-coated carbon fiber had 45 wt. % of PA6 resin based on the total weight of the PA6 resin, carbon fiber and sizing additives. FIG. 4 shows a photograph of spools of sized and PA6 resin-coated carbon fibers. FIG. 5 shows a photomicrograph of sized and PA6 resin-coated carbon fibers.

### Example 3: Method of Making a Carbon Fiber Reinforced Composite

The as-prepared sized and PA6 coated carbon fibers were molded at 250° C. for 60 min, without addition of additional PA6 resin or some other resin, into a test panel (2 mm thick, 200 mm width and 300 mm length).

The carbon fiber reinforced composite test panel was tested for interlaminar shear strength (ILSS) by method ISO 14130 and showed a maximum shear strength of 60 MPa, which is in line with the state of the art.

It will be apparent to those skilled in the art that various modifications and variations can be made in the practice of the present invention without departing from the scope or spirit of the invention. Other embodiments of the invention will be apparent to those skilled in the art from consideration of the specification and practice of the invention. It is intended that the specification and examples be considered as exemplary only, with a true scope and spirit of the invention being indicated by the following claims.

1. A method of making a sized and resin-coated fiber tow for use in a fiber reinforced composite, the method comprising the steps of:
a) providing a carbon fiber;
b) contacting at least a portion of the fiber with a sizing slurry to form a sized and resin-coated fiber, the sizing slurry comprising 0.1-25 wt. % of a sizing agent and 20-80 wt. % of a matrix-resin powder in a solvent, wherein the amounts in wt. % are based on the total amount of the sizing slurry, such that the total solid content, including the sizing agent and the matrix-resin powder, of the sizing slurry is greater than 30 wt. %;
c) drying the sized and resin-coated fiber at a temperature below the melting point of the matrix-resin powder, thereby forming a dried sized and resin-coated fiber; and
d) winding the dried sized and resin-coated fiber onto a spool.

2. The method according to claim 1, wherein the method is a continuous process further comprising steps (i)-(iv) before the step of contacting at least the portion of the fiber with the sizing slurry:
(i) stabilizing a precursor fiber at a temperature in the range of 200-300° C. to form a stabilized precursor fiber;
(ii) carbonizing the stabilized precursor fiber at a temperature in the range of 1000-1500° C. to form a carbonized fiber;
(iii) graphitizing the carbonized fiber at a temperature in the range of 2000-3000° C. to form a carbon fiber; and
(iv) optionally treating at least a portion of a surface of the carbon fiber.

3. The method according to claim 1, wherein the drying step provides the dried sized and resin-coated fiber having greater than 21 wt. % and less than 80 wt. % of the sizing agent and the matrix-resin based on the total amount of the dried sized and resin-coated fiber.

4. The method according to claim 1, wherein the contacting step includes providing the sizing slurry comprising the matrix-resin powder having an average particle size in the range of 1-500 μm.

5. The method according to claim 1, wherein the contacting step includes providing the sizing slurry comprising the sizing agent comprising at least one of an epoxy, a phenoxy, a polyester, a polyamide, a polyimide, a polypropylene, a polyurethane, a polyvinyl acetate, a vinyl-ester, a polyvinyl alcohol, an ethylene/vinyl alcohol copolymer, a silane-grafted polyvinyl alcohol and a silane-grafted ethylene/vinyl alcohol copolymer, a silane-grafted polyvinyl alcohol, a silane-grafted ethylene/vinyl alcohol copolymer, and the like.

6. The method according to claim 1, wherein contacting step includes providing the sizing slurry comprising the matrix-resin powder which is a thermoset (co)polymer, a thermoplastic (co)polymer, or alloys and blends thereof.

7. The method according to claim 6, wherein contacting step includes providing the sizing slurry comprising the thermoset (co)polymer comprising epoxy, vinyl ester polyester, bismaleimide, cyanate ester, polyurethane, or mixtures thereof.

8. The method according to claim 6, wherein contacting step includes providing the sizing slurry comprising the thermoplastic (co)polymer comprising polyethylene, polypropylene, polycarbonate, polyethylene terephthalate, polybutylene terephthalate, polyamide-6, polyamide-66, polyamide-11, polyamide-12, polyamide-46, polyetherimide, polyphenylene sulfide, polysulfone, polyimide, polyethersulfone, polyether-ketone-ketone, polyether-ether-ketone, or mixtures thereof.

9. The method according to claim 1, further comprising molding the dried sized and resin-coated fiber without impregnating the dried sized and resin-coated fiber with additional matrix-resin.

10. A fiber reinforced composite prepared by the method according to claim 1.

11. A sizing slurry comprising 0.1-25 wt. % of a sizing agent and 20-80 wt. % of a matrix-resin powder in a solvent, wherein the amounts in wt. % are based on the total amount of the sizing slurry, such that the total solid content, including the sizing agent and the matrix-resin powder, of the sizing slurry is greater than 30 wt. %.

12. A sized and resin-coated fiber comprising:
(i) a carbon fiber,
(ii) a sizing agent disposed on at least a portion of the fiber, and
(iii) a matrix-resin disposed on at least a portion of the fiber and adhered to the sizing agent,
wherein the sized and resin-coated fiber has greater than 21 wt. % and less than 80 wt. % of the sizing agent and matrix-resin, based on the total weight of the sized and resin-coated fiber.

13. A continuous method of making a sized and resin-coated carbon fiber tow for use in a carbon fiber reinforced composite, the method comprising the steps of:
e) unwinding a spool of polyacrylonitrile (PAN) fiber;
f) stabilizing the PAN fiber at a temperature in the range of 200-300° C. to form a stabilized PAN fiber;
g) carbonizing the stabilized PAN fiber at a temperature in the range of 1000-1500° C. to form a carbonized fiber;
h) graphitizing the carbonized fiber at a temperature in the range of 2000-3000° C. to form a carbon fiber;
i) treating at least a portion of a surface of the carbon fiber;
j) contacting at least a portion of the fiber with a sizing slurry to form a sized and resin-coated fiber, the sizing slurry comprising 0.1-25 wt. % of a sizing agent and 20-80 wt. % of a matrix-resin powder in a solvent, wherein the amounts in wt. % are based on the total amount of the sizing slurry, such that the total solid content, including the sizing agent and the matrix-resin powder, of the sizing slurry is greater than 30 wt. %;
k) drying the sized and resin coated carbon fiber at a temperature below the melting point of resin, thereby forming a dried sized and resin-coated carbon fiber; and
l) winding the dried sized and resin-coated carbon fiber onto a spool.

14. The continuous method according to claim 13, wherein the drying step provides the dried sized and resin-coated fiber having greater than 21 wt. % and less than 80 wt. % of the sizing agent and the matrix-resin, based on the total amount of the dried sized and resin-coated fiber.

15. The continuous method according to claim 13, further comprising molding the dried sized and resin-coated fiber without impregnating the dried sized and resin-coated carbon fiber with additional matrix-resin.
